(19) United States
(12) Patent Application Publication
(10) Pub. No.: US 2010/0000063 A1
(43) Pub. Date: Jan. 7, 2010

(54) METHOD AND DEVICE FOR REPAIRING THE LIQUID-COOLED ELECTRICAL WINDINGS OF THE STATOR OF AN ELECTRIC GENERATOR

(75) Inventors: Domenico Vallarino, Genova (IT); Giorgio Vercelli, Genove (IT)

Correspondence Address: DARBY & DARBY P.C., P.O. BOX 770, Church Street Station, New York, NY, 10008-0770, US

(73) Assignee: Ansaldo Energia S.p.A., Genova (IT)

(21) Appl. No.: 12/376,177

(22) PCT Filed: Aug. 3, 2006
(86) PCT No.: PCT/IT06/00599

§ 371 Date: May 27, 2009

(51) Int. Cl. H02K 15/00; B23P 6/00; B26D 1/12

(52) U.S. Cl. 29/402.21; 407/53; 29/732

(57) ABSTRACT

A method for repairing the liquid-cooled electrical windings of the stator of an electric generator, in which each electrical winding has a plurality of bars, which are set alongside one another and, in part, have channels for conveying the cooling fluid, and a terminal, which has, on one side, an opening, inserted in which are the ends of the bars and, on the other side, a fitting for connection to a connector pipe for supply or discharge of the cooling fluid, envisages the steps of: a) cutting the terminal into a first portion comprising the opening, and a second portion comprising the fitting, the cut producing a first cutting surface along the first portion; b) cleaning the free ends of the bars housed in the first portion; c) hermetically joining the free ends of the bars to one another and to the first portion via TIG welding in a helium atmosphere; d) facing the first cutting surface; e) selectively regulating the position between the second portion and the first portion for re-composing the terminal; f) induction brazing the second portion to the first portion; and g) performing at least one of the steps a), d) and e) by means of a repair device, which can be anchored to the first portion.

### TECHNICAL FIELD

The present invention relates to a method for repairing the liquid-cooled electrical windings of the stator of an electric generator. Generally, an electric generator is incorporated in a train of high-power turbomachines.

### BACKGROUND ART

The stator of an electric generator has a plurality of electrical windings, the number of which is a function of the schematic circuit diagram of the generator. A liquid-cooled electrical winding comprises: a bundle of copper bars, which are set alongside one another and, in part, have channels for conveying the cooling fluid; and two terminals, which are usually arranged at the opposite ends of the bundle of conductive bars for conveying the cooling fluid entering and exiting the winding. The bars each have a substantially rectangular cross section and are set alongside one another to form the bundle, which has a substantially rectangular cross section. The opposite ends of the bundle, and hence of the bars, are fixed within the respective terminals. Each terminal has the form of a tube and has, on one side, an opening, inserted in which are the ends of the bars and, on the other side, a fitting for connection to a connector pipe for supply or discharge of the cooling fluid.

In the course of time, in electrical windings of the type described, cooled with demineralized water, leakage of demineralized water can occur. In particular, the demineralized water encourages a phenomenon of galvanic corrosion that jeopardizes hydraulic tightness, in particular, between the bars and the terminal itself. A possible leakage of demineralized water constitutes extremely serious damage to the entire generator. To overcome this problem, it is known, for example from the document No. U.S. Pat. No. 5,760,371, to carry out interventions of maintenance that envisage performing the following operations: cutting the terminal into a first portion comprising the opening and a second portion comprising the fitting; cleaning the free ends of the bars housed in the first portion; hermetically joining the free ends of the bars to one another and to the first portion; keeping the second portion facing the first portion in order to re-compose the terminal; and joining the second portion to the first portion.

The operations described above call for dismantling of the generator, in particular, removal of the rotor from the stator, and even in some cases dismantling of the electrical windings.

Removal of the rotor of a turbogenerator and even more disassembly of the electrical windings of the stator are burdensome operations, from the standpoint of costs and above all of the time involved.

### DISCLOSURE OF INVENTION

The aim of the present invention is to provide a method for repairing the liquid-cooled electrical windings of the stator of an electric generator that will be free from by the drawbacks of the known art and that, in particular, will not entail removal of the rotor of the turbogenerator and dismantling of the electrical windings and, at the same time, will allow an intervention of repair to be carried out in short times and with a high level of accuracy.

In accordance with said aims, the present invention relates to a method for repairing the liquid-cooled electrical windings of the stator of an electric generator, each electrical winding comprising: a plurality of copper bars, which are set alongside one another and, at least in part, have channels for conveying the cooling fluid; and a terminal, which extends along a first axis and has, on one side, an opening, inserted in which are the ends of the bars and, on the other side, a hydraulic fitting for connection to a connector pipe for supply or discharge of the cooling fluid; said method comprising the steps of:

a) cutting the terminal into a first portion comprising said opening and a second portion comprising said fitting; cutting of the terminal generating a cutting surface along the first portion;
b) cleaning the free ends of the bars housed in the first portion;
c) hermetically joining via welding the free ends of the bars to one another and to the first portion;
d) facing the cutting surface;
e) selectively regulating the position between the first and second portions for re-composing the terminal; and
f) brazing the second portion to the first portion;
the method being characterized in that at least one of the steps a), d) and e) is performed by means of a repair device which can be anchored to said first portion.

The present invention moreover relates to a repair device for repairing the liquid-cooled electrical windings of the stator of an electric generator.

According to the present invention, a device is provided for repairing the liquid-cooled electrical windings of the stator of an electric generator; each electrical winding comprising: a plurality of conductive bars, which are set alongside one another and, at least in part, have channels for conveying the cooling fluid; and a terminal, which extends along a first axis and has, on one side, an opening, inserted in which are the ends of the bars and, on the other side, a fitting for connection to a connector pipe for supply or discharge of the cooling fluid; it being possible for the terminal to be cut into a first portion and a second portion; the repair device being characterized in that it comprises: a frame which can be anchored to the first portion; and a member that is mobile with respect to the frame and is designed to execute at least one of steps a), d), and e) of the method claimed in any of claims 1 to 12.

### BRIEF DESCRIPTION OF THE DRAWINGS

Further characteristics and advantages of the present invention will appear clearly from the ensuing description of a non-limiting example of embodiment, with reference to the figures of the annexed plate of drawings, wherein:

FIG. 1 is a longitudinal section, with parts removed for reasons of clarity, of a liquid-cooled electrical winding of the stator of an electric generator;

FIG. 2 is a cross-sectional view of the electrical winding of FIG. 1 taken according to the lines of cross section II-II;

FIG. 3 is a longitudinal section, with parts removed for reasons of clarity, of the electrical winding of FIG. 1, in which the terminal is cut into a first portion and a second portion;

FIG. 4 is a side elevation, with parts in cross section and parts removed for reasons of clarity, of a cutting device for cutting the terminal into the first portion and second portion in accordance with the present invention;

FIG. 5 is a side elevation, with parts in cross section and parts removed for reasons of clarity, of a facing device in accordance with the present invention; and

FIG. 6 is a side elevation, with parts in cross section and parts removed for reasons of clarity, of a device for re-composition of the terminal made in accordance with the present invention.

### BEST MODE FOR CARRYING OUT THE INVENTION

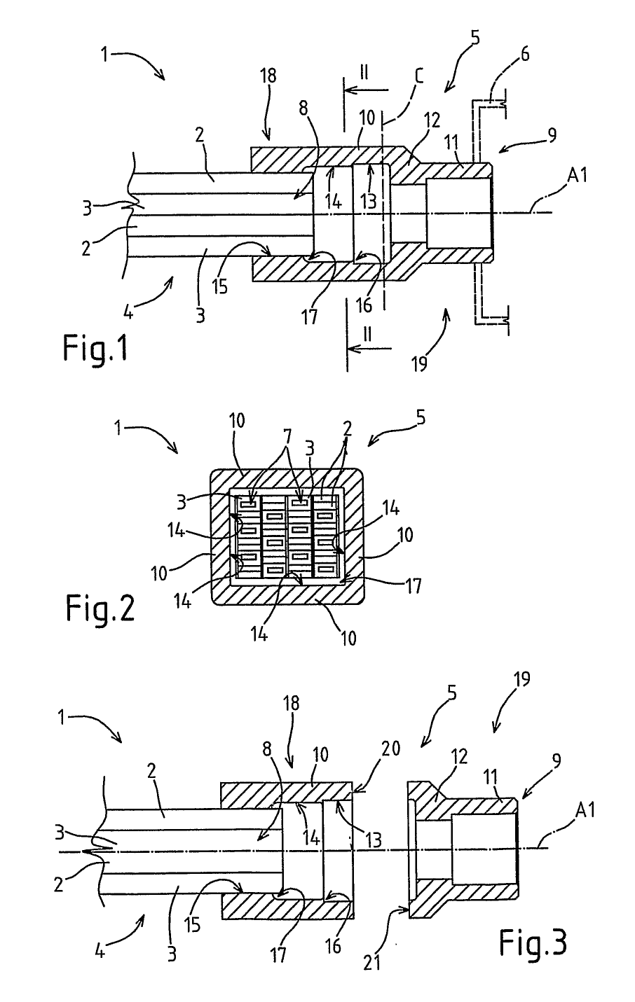

With reference to FIG. 1, designated as a whole by 1 is an electrical winding of the stator of an electric generator. The electrical winding 1 is of the type cooled with demineralized water and comprises: copper bars 2 and 3, which are set alongside one another to form a bundle 4 having a substantially rectangular cross section (FIG. 2); and two terminals 5 (only one of which is illustrated in FIG. 1), which are fixed at the opposite ends of the bundle 4. Each terminal 5 is fixedly connected by means of a connector pipe 6 (illustrated with dashed lines in FIGS. 1 and 3) to a collector for supply or discharge of the demineralized water (of a type known and not illustrated in the attached figures).

With reference to FIG. 2, each bar 2 has a full cross section and a rectangular shape, whilst each bar 3 has a channel 7 that extends throughout the length of the bar 3 and a rectangular cross section. The bars 3 are uniformly distributed between the bars 2 and transposed therewith, according to specific schemes, in the section of the bundle 4.

With reference to FIG. 1, each terminal 5 comprises: an opening 8, through which the bundle 4 is inserted in part within the terminal 5; and a fatting 9, which is designed to connect the terminal 5 to a connector pipe 6.

Each terminal 5 is designed to provide direct-cooling electrical connections of the type described in U.S. Pat. No. 3,693,036, has substantially the shape of a tube, extends along an axis A1, and comprises four plane walls 10, which are parallel to one another and to the axis A1, whilst the fitting 9 comprises a cylindrical wall 11 of axis A1. The cross section defined by the cylindrical wall 11 is sensibly smaller than the cross section defined by the plane walls 10. Then, the cylindrical wall 11 is connected to the plane walls 10 by walls 12 inclined with respect to the axis A1. Each plane wall 10 has a thickness increasing in the direction of the opening 8 and defines in succession three fares 13, 14 and 15: the face 13 is substantially cylindrical and is separated from the face 14 by a contrast element 16; and the face 14 is separated from the face 15 by a contrast element 17. The face 15 is in contact with the bundle 4 to which it is hermetically sealed. In the same way, the ends of the adjacent bars 2 and 3 are hermetically sealed to one another to prevent any possible leakage of demineralized water.

In FIG. 1, the dashed line designated by the letter C indicates a preferred plane of sectioning of the terminal 5 so as to facilitate access to the ends of the bars 2 and 3 contained within the terminal 5. The plane of sectioning C is perpendicular to the axis A1, extends through the thinner portion of the plane walls 10 and ideally divides the terminal 5 into a portion 18 comprising the opening 8, and a portion 19 comprising the fitting 9.

With reference to FIG. 3, the portions 18 and 19 are separate from and face one another. Cutting of the terminal 5 produces a cutting surface 20 on the portion 18 and a cutting surface 21 on the portion 19.

The operations for repairing the electrical windings comprise the steps of:
cutting the terminal 5 to form the portion 18 comprising the opening 8, and the portion 19 comprising the fitting 9;
cleaning the internal compartment of the portion 18 and, in particular the free ends of the bars 2 and 3, housed in the portion 18;
hermetically sealing the free ends of the bars 2, 3 by welding them to one another and to the portion 18;
facing the cutting surfaces 20 and 21;
selectively adjusting the relative position between the portions 18 and 19 for re-composing the terminal 5; and
brazing the portions 18 and 19.

The method of the present invention envisages carrying out all the operations listed above, without removing the rotor from the stator (not illustrated in the attached figures) and without taking the electrical winding 1 down from the stator (not illustrated). In other words, the method envisages carrying out all the operations with the exception, for example, of facing of the cutting surface 21 of the portion 19, which, since it is a portion separate from the electrical winding 1, can be conveniently transferred and worked in a toolroom. In particular, the method envisages the use of repair devices that can be anchored to the portion 18.

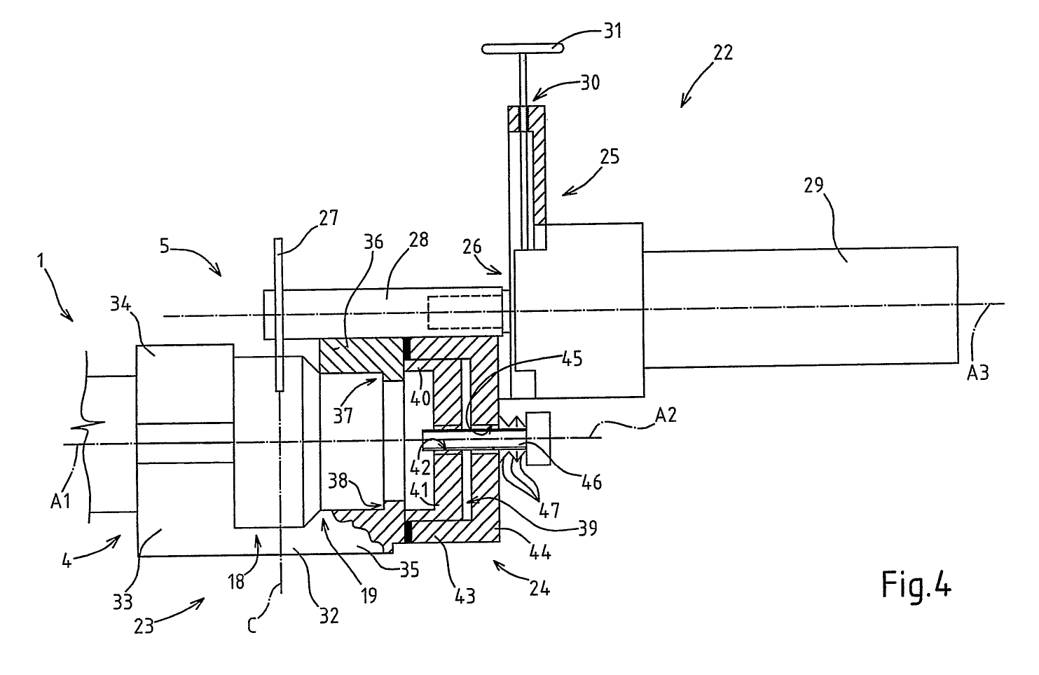

The operation of cutting of the terminal 5 is performed by means of a cutting device 22, which can be fixed directly to the electrical winding 1. In particular and with reference to FIG. 4, the cutting device 22 can be fixed to the terminal 5 and comprises: a frame 23, which can be anchored to the terminal 5 and extends along an axis A2; a mobile drum 24 mounted on the frame 23 so that it can turn about the axis A2; a guide 25 extending radially with respect to the axis A2 from the mobile drum 24; a slide 26 which can slide along the guide 25 in a portion perpendicular to the axis A2; and a disk-type milling cutter 27, which is mounted on a shaft 28 that can rotate about an axis A3 parallel to the axis A2. The shaft 28 is supported by the slide 26 and is driven in rotation about the axis A3 by a pneumatic motor 29. The position of the slide 26 along the guide 25 is adjusted by an internal screw-external screw mechanism 30, operated by a handwheel 31 for adjusting the depth of cutting of the disk-type milling cutter 27.

The frame 23 comprises: a plate 32; a half-ring 33, which is fixed to the plate 32 and has a seat designed to be size-fitted to part of the external profile of the portion 18; and a half-ring 34, which has a seat designed to be size-fitted to part of the external profile of the portion 18 and is complementary to the half-ring 33 for gripping part of the portion 18. In this way, the entire cutting device 22 is fixed to the electrical winding 1.

The frame 23 comprises a half-ring 35, which can be fitted to the cylindrical wall 11 and is fixed to the plate 32, and a half-ring 36, which can be fitted to the half-ring 35 for gripping the cylindrical wall 11 and arranging the axis A2 so that it substantially coincides with the axis A1. The half-rings 35 and 36 have contrast elements 37 and 38 designed to be arranged bearing upon the free end of the fitting 9 so as to set the disk-type milling cutter 27 so that it substantially coincides with the plane of sectioning C.

The frame 23 comprises a drum 39, which is fixed to the plate 32, and comprises a cylindrical wall 40 of axis A2 and a disk 41, which is joined to the cylindrical wall 40 and is provided with a threaded central hole 42. The mobile drum 24 comprises a cylindrical wall 43 and a disk 44, which is joined to the cylindrical wall 43 and is provided with a central hole 45. The mobile drum 24 is fitted to the drum 39 by means of a screw 46 screwed in the hole 42 and a series of Belleville washers 47 that compress the disk 44 against the disk 41. The screw 46 enables adjustment of the compression of the springs 47 and, consequently, the friction between the mobile drum 24 and the drum 39.

In use, once the cutting device 22 has been mounted on the terminal 5, the pneumatic motor 29 is actuated to drive the disk-type milling cutter 27 in rotation. Next, the slide 25 is brought up to the axis A2 so that the disk-type milling cutter 27 penetrates progressively into the terminal 5 in a position corresponding to the plane of sectioning C. Once a wall 10 has been traversed, the mobile drum 24 is rotated slowly about the axis A2, taking care to prevent cutting of the plate 32. Since the plate 32 prevents a complete separation of the portions 18 and 19, once part of the cut has been performed, the cutting device 22 is taken down from the terminal 5 and remounted on the same terminal 5 in a position rotated by 180° with respect to the axis A1 so as to complete the remaining part of the cut. During the operations of cutting for milling of the terminal 5, in order to limit the contamination by dust and swarf inside the hollow bars 3, argon or nitrogen gas is blown in through the opposite end of the winding 1. As a substitute for nitrogen and argon, other inert and/or hygroscopic gases may be used; also dry air is suitable for the purpose.

The operations of cleaning of the free ends of the bars 2, 3 housed in the portion 18 preferably envisage an end milling of the ends of the bars 2 and 3 with portable equipment (not illustrated) and, if necessary, electro-galvanic erosion with a solution preferably of nitric acid and sulphuric acid.

Next, cleaning is carried out by flushing twice with demineralized water. If necessary, the residue of the acid solution and of the flushing can be eliminated by the production of a vacuum within the bundle 4, after prior application of a blind flange (not illustrated in the attached figures) to the portion 18 of the terminal 5, and the connection of the other end of the electrical winding 1 to a vacuum pump.

The hollow bars 3 must finally be flared with specifically shaped millers, to reduce the risk of obstruction of the hollow bars 3 in the welding step.

At the end of the operations of cutting of the terminal 5 and of milling of the hollow bars 3, the inside of the terminal 5 is cleaned preferably with a chlorinated agent, such as trichloroethane, and then aspirated.

The hermetic sealing of the free ends of the bars 2, 3 to one another and to the portion 18 is performed by TIG welding (not illustrated in the attached figures), in controlled atmosphere using helium as shielding gas at a flow rate of approximately 8 l/min. The use of helium gas enables a temperature of the electric arc of the torch to be reached higher than that of other shielding gases, and makes it possible to direct and focus the electric arc with greater ease. The aforesaid process of welding ensures a high specific thermal capacity, facilitates the process itself, minimizes overheating of the bars 2 and 3. If necessary, brazing alloy is applied; i.e., there is a passage from a pure welding to a brazing. The brazing alloy must have a high content of copper, and may in any case also be a bronze-based alloy. It is in this case all the more necessary to adopt a specific combined sequence of welding and/or brazing operations for preventing formation of cracks during solidification of the weld puddle.

Next, a check is made with penetrating liquids, as well as a series of tests to guarantee the hydraulic tightness of the assembly of the bars 2 and 3 and of the portion 18, according to modalities that are known and not illustrated.

Before proceeding to re-composition of the sectioned terminal 5, the surfaces 20 and 21 are faced. The operation of facing on the portion 19 can be conveniently performed in a toolroom, whilst the operation of facing on the portion 18 is performed in situ with the aid of a facing device 48 that is designed for said purpose and can be coupled to the portion 18 of the terminal 5.

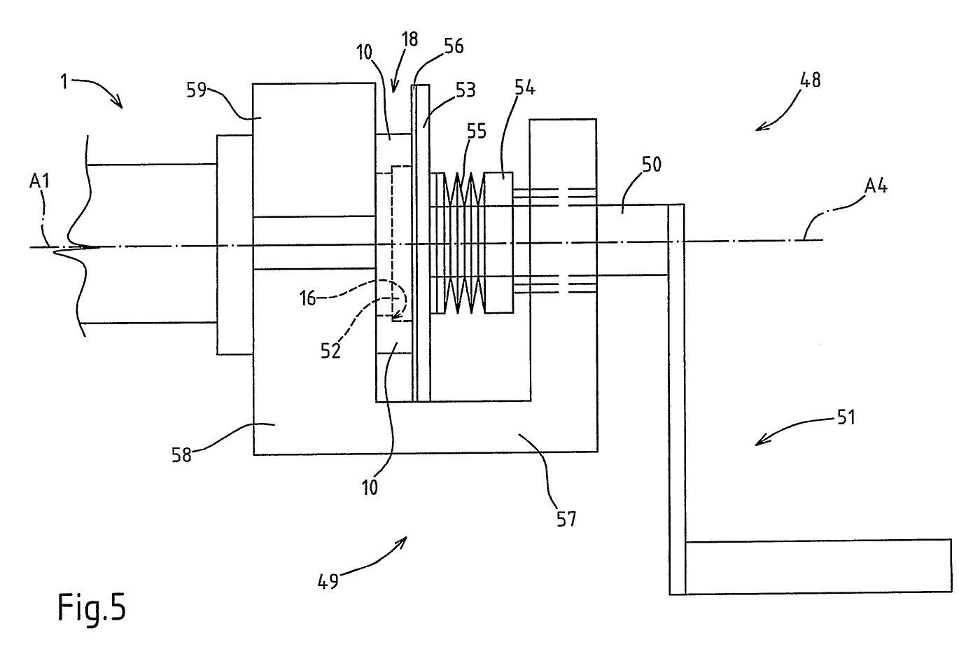

With reference to FIG. 5, the facing device 48 comprises: a frame 49 designed to be fixed to the portion 18; and a shaft 50, which is supported by the frame 49 and can rotate about an axis A4. The shaft 50 has, in a position corresponding to one end, a crank 51, which, in one embodiment (not illustrated), is replaced by a pneumatic actuator, and, in a position corresponding to the opposite end, by a drum 52 which is designed to be inserted within the portion 18 bearing upon the contrast element 16. The device 48 comprises: a supporting disk 53 slidably mounted on the shaft 50; a ring nut 54 arranged around the shaft 50 and screwed to the frame 49; and a spring 55 set between the ring nut 54 and the frame 49. The ring nut 54 enables adjustment of the compression of the spring 55 against the supporting disk 53. The facing device 48 comprises a disk of abrasive material 56 that can be inserted between the drum 52 and the disk 53.

The frame 49 comprises: an L-shaped beam 57, connected to a half-ring 58 provided with a seat that can be size-fitted to the portion 18; and a half-ring 59 that can be fitted to the half-ring 58 for gripping the portion 18.

In use, the facing device 48 is mounted on the portion 18 in such a way that the axis A3 coincides substantially with the axis A1, and the drum 52 is set bearing upon the contrast element 16. Rotation of the crank 51 brings about rotation of the abrasive disk 56 over the surface 21 so as to reduce sensibly the roughness of said surface 21.

The subsequent operation of re-joining of the portions 18 and 19 envisages arrangement of the portions 18 and 19 facing one another and the possibility of adjusting the distance between the cutting surfaces 20 and 21 The portions 18 and 19 are held in position by means of a specifically designed re-composition device 60.

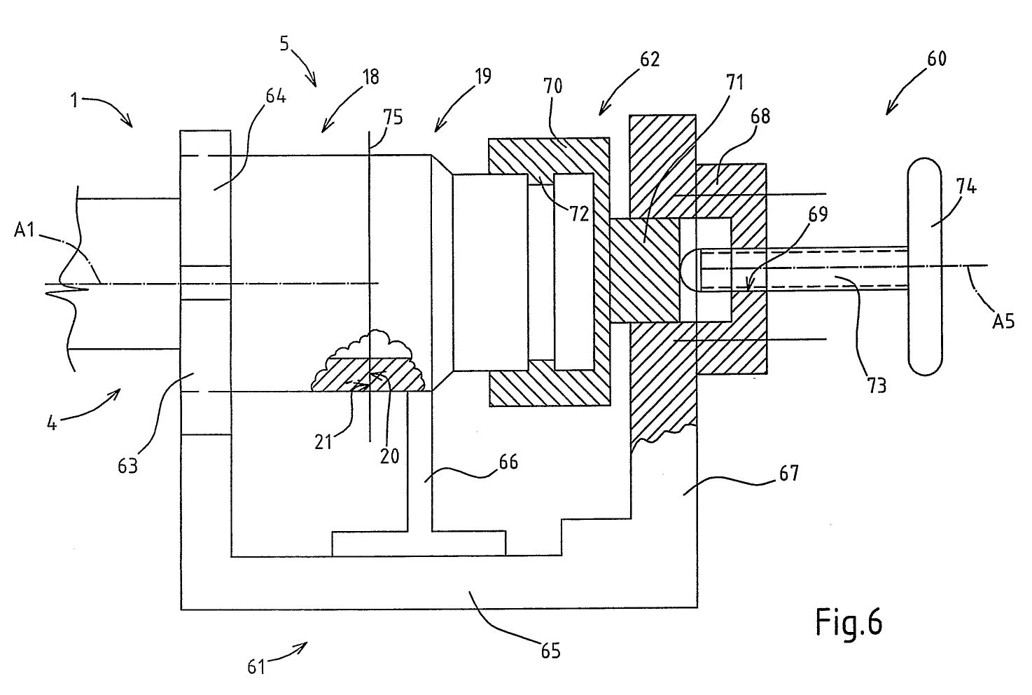

With reference to FIG. 6, the re-composition device 60 comprises: a frame 61, designed to be fixed to the portion 18; and a slide 62, which can slide with respect to the frame 61 and is designed to be coupled to the portion 19. The frame 61 comprises: a half-ring 63 fixed to the frame 61; a half-ring 64, which can be coupled to the half-ring 63 so as to grip the portion 18; a connection plate 65; a contrast bracket 66, fixed to the plate 65; and a plate 67, which is set transverse to the plate 65 and has a pocket 68 for housing the slide 62 and a threaded hole 69 of axis A5.

The slide 62 comprises a cuplike, body 70 joined to a prismatic body 71, which is coupled in a prismatic way to the pocket 68, within which it can slide in a direction parallel to the axis A5. The cuplike body 70 is designed to house the free end of the fitting 9 of the portion 19 and has an annular rib 72, set bearing upon which is the fitting 9. The supporting device 60 comprises a screw 73 coupled to the threaded hole 69 and provided with an operating handwheel 74, and one end set in the pocket 68 to push the slide 62. The pitch of the threads of the screw 73 and of the threaded hole 69 is selected so as to enable micrometric adjustment between the surfaces 20 and 21 of the respective portions 18 and 19.

In use, the portion 19 is inserted in the cuplike body 70, and the frame 61 is fixed to the portion 18 in such a way that the axis A5 is substantially aligned to the axis A1. By means of rotation of the handwheel 74, the surfaces 20 and 21 are brought closer to one another.

The operation of brazing of the portions 18 and 19 envisages insertion of two foils 75 of brazing alloy, which have a thickness of 0.127 mm and are of the BcuP-5 type, between the surfaces 20 and 21 and gripping of the foils 75 by means of the screw 70 between the portions 18 and 19. Next, an induction coil (not illustrated in the attached figures) is actuated; the induction coil, preferably with magnetic plates for guiding the field, is supplied in power at medium frequency, of the order of 10 kHz, for an active power available on the workpiece of approximately 30 kW.

The assembly of the two portions 18 and 19 of the terminal 5 and of the foils of brazing alloy 75 is heated until the copper reaches a cherry-red colour, corresponding to a temperature of approximately 650° C.

When the brazing alloy is in the fluid state, between 650° C. and 750° C., the handwheel 74 is operated to bring the portions 18 and 19 closer together to approximately two tenths of a millimetre, quantifiable in an angle of rotation of the handwheel 74 predetermined on the basis of the pitch of the screw 73, so as to achieve a brazing clearance smaller than 0.1 mm.

Once brazing has been carried out, the electrical winding 1 is subjected to a test for hydraulic tightness according to modalities that are known and not illustrated herein.

The main advantage that emerges from the present invention is that of preventing the need for complex and costly operations of dismantling of the generator thanks to the use of repair devices designed to engage to the electrical winding or to a part thereof. Furthermore, said repair devices enable the various operations of repair to be carried out with a high degree of accuracy and in relatively short times.

1. A method for repairing the liquid-cooled electrical windings of the stator of an electric generator; each electrical winding comprising: a plurality of conductive bars, which are set alongside one another and, at least in part, have channels for conveying the cooling fluid; and a terminal, which extends along a first axis (A1) and has, on one side, an opening, inserted in which are the ends of the bars and, on the other side, a fitting for hydraulic connection to a connector pipe for supply or discharge of the cooling fluid; said method comprising the steps of:
a) cutting the terminal into a first portion comprising said opening (8) and a second portion (19) comprising said fitting; cutting of the terminal generating a cutting surface along the first portion;
b) cleaning the free ends of the bars housed in the first portion;
c) hermetically joining the free ends of the bars to one another and to the first portion;
d) facing the cutting surface; and
e) selectively regulating the position between the first portion and the second portion for re-composing the terminal;
f) induction brazing the second portion to the first portion;
said method being characterized in that at least one of the steps a), d) and e) is performed by means of a repair device, which can be anchored to said first portion.

2. The method according to claim 1, wherein each of steps a), d) and e) is carried out by a corresponding repair device, which can be anchored to said first portion.

3. The method according to claim 1, wherein said repair device is a cutting devices, which comprises; a frame that can be anchored to the first and second portions); and a disk-type milling cutter, which is mobile with respect to the frame; said method envisaging fixing the frame to the first and second portions so as to arrange the disk-type milling cutter so that it substantially coincides with an ideal sectioning plane.

4. The method according to claim 3, wherein the disk-type milling cutter is mounted so that it can turn with respect to said frame about a second axis and rotates about a third axis parallel to the second axis; said method envisaging fixing the frame to the first and second portions so as to arrange the first and second axes in substantial mutual alignment.

5. The method according to claim 4, characterized in selectively varying the distance between the second and third axes for regulating and varying progressively the cutting depth.

6. The method second to claim 1, wherein said repair device is a facing device comprising a frame, which can be anchored to the first portion and a disk of abrasive material that can rotate with respect to the frame; said method envisaging anchorage of the frame to the first portion, setting the disk of abrasive material against the first cutting surface, and rotation of the disk of abrasive material with respect to the frame and to the first portion.

7. The method according to claim 6, characterized in rotating the disk of abrasive material about a fourth axis and setting the fourth axis so that it substantially coincides with the first axis.

8. The method according to claim 1, wherein the repair device is a composition device comprising a frame and a slide, which is slidably mounted with respect to the frame along a fifth axis; said method envisaging fixing the frame to the first portion so as to set the fifth axis so that it substantially coincides with the first axis; inserting the second portion on the slide; and adjusting the distance between the first portion and the second portion, causing the slide to slide with respect to the frame.

9. The method according to claim 8, characterized in arranging two foils of brazing alloy between the first portion and the second portion, and gripping the foils of brazing alloy between the first portion and the second portion by sliding the slide.

10. The method according to claim 9, characterized in melting the foils of brazing alloy and bringing the first and second portions closer together by means of said slide.

11. The method according to claim 1, wherein the step of cleaning comprises milling of the ends of the bars and electro-galvanic erosion with a mixture preferably of nitric acid and sulphuric acid.

12. The method according to claim 1, wherein the step of joining the ends of the bars to one another and to the first portion envisages welding the bars to one another and to the first portion via TIG welding in a controlled atmosphere of pure helium.

13. A device for repairing the liquid-cooled electrical windings of the stator of an electric generator; each electrical winding comprising: a plurality of conductive bars, which are set alongside one another and, at least in part, have channels for conveying the cooling fluid; and a terminal, which extends along a first axis and has, on one side, an opening, inserted in which are the ends of the bars, and, on the other side, a fitting for connection to a connector pipe for supply or discharge of the cooling fluid; it being possible to cut the terminal into a first portion and a second portion; the repair device being characterized in that it comprises: a frame, which can be anchored to the first portion; and a member, which is mobile with respect to the frame and is designed for carrying out at least one of the steps a), d), and e) of the method claimed claim 1.

14. The device according to claim 13, characterized in that the repair device is a cutting device and the member is a disk-type milling cutter, designed for cutting the terminal into the first and second portions.

15. The device according to claim 14, wherein the frame extends along a second axis; the disk-type milling cutter being rotatable about a third axis parallel to the second axis.

16. The device according to claim 15, wherein the disk-type milling cutter is designed to perform a partial revolution about the second axis.

17. The device according to claim 16, wherein the disk-type milling cutter is supported by a shaft mounted so that it can turn on a slide, which can slide along a guide transverse to the second axis for adjusting the distance between the disk-type milling cutter and the second axis.

18. The device according to claim 17, wherein it comprises a mobile drum mounted on the frame so that it can turn about the second axis; said guide being fixed to the mobile drum.

19. The device according to claim 18, characterized in that it comprises compression means adjustable for varying the friction between the frame and the mobile drum.

20. The device according to claim 15, wherein the frame comprises coupling means for engaging the frame to the terminal and substantially aligning the second axis to the first axis.

21. The device according to claim 14, wherein the frame has a contrast element designed to be set so that it bears upon the terminal in such a way as to set the disk-type milling cutter in a given position along the first axis and so that it substantially coincides with an ideal sectioning plane.

22. The device according to claim 14, wherein it comprises a pneumatic motor for turning the disk-type milling cutter.

23. The device according to claim 13, wherein the repair device is a facing device (48) and the member is a disk of abrasive material; the facing device comprising a frame and the disk of abrasive material being mounted so that it can turn about a fourth axis with respect to the frame for facing a first cutting surface of the first portion; the first cutting surface being set perpendicular to the first axis.

24. The device according to claim 23, wherein the frame comprises means for engaging the frame to the first portion and setting the fourth axis in substantial alignment with the first axis.

25. The device according to claim 24, wherein the disk of abrasive material rests on a supporting disk set on a shaft that can rotate about the fourth axis.

26. The device according to claim 25, wherein it comprises a drum mounted on one end of the shaft and designed to be inserted in the first portion and set bearing upon a contrast element of the first portion.

27. The device according to claim 25, wherein it comprises means for compressing the supporting disk against the terminal; the compression means being set between the supporting disk and the frame.

28. The device according to claim 27, wherein said compression means are arranged about the shaft and comprise at least one spring and one ring nut, which can be screwed in the frame for adjusting the compression of the spring between the ring nut Hand the supporting disk.

29. The device according to claim 23, wherein it comprises an actuation member for setting the disk of abrasive material in rotation about the fourth axis.

30. The device according to claim 13, wherein the repair device is a re-composition device and the member is a slide; the re-composition device comprising a frame, which can be engaged to the first portion, and the slide, which can be coupled to the second portion and can slide with respect to the frame along a fifth axis.

31. The device according to claim 30, wherein the frame comprises means of engagement to the first portion so as to set the fifth axis so that it substantially coincides with the first axis.

32. The device according to claim 31, wherein the slide comprises a contrast element designed to determine a given position of the second portion with respect to the slide.

33. The device according to claim 30, wherein it comprises means for controlling the displacement of the slide with respect to the frame.
